(19) United States
(12) Patent Application Publication
(10) Pub. No.: US 2006/0012605 A1
(43) Pub. Date: Jan. 19, 2006

(54) Method for transmitting digital color documents

(76) Inventors: Martin Beyer, Bergkamen (DE); Francis Lamy, Wollerau (AU); Thomas Senn, Dielsdorf (CH); Iris Mangelschots, Kilchberg/ZH (CH)

Correspondence Address: MCCARTER & ENGLISH LLP;CITYPLACE I, 185 ASYLUM STREET, HARTFORD, CT, 06103, US

(21) Appl. No.: 11/122,348

(22) Filed: May 5, 2005

(30) Foreign Application Priority Data
May 5, 2004 (EP) 04 010724.5

(51) Int. Cl. G09G 5/02

(52) U.S. Cl. 345/589

(57) ABSTRACT

A digital color document is generated or processed on a first computer by way of a color management enabled graphics application, by using a monitor-profile. The digital data of the color document are packed together with the underlying monitor-profile into a digital container document and transmitted to a second computer. The container document is unpacked in the second computer, whereby the data of the color document and the underlying monitor-profile are recovered. The unpacked monitor-profile is compared with a local monitor-profile active in the second computer and the comparison outcome is displayed on the monitor of the second computer.

### BACKGROUND OF THE INVENTION

The invention relates to a method for transmitting to at least one second computer of a digital color document generated or processed on a first computer by way of a color management enabled graphics application using a monitor profile to at least a second computer.

In the classical practice, the photographer or designer offered their work to the client in the form of physical pictures (e.g., prints or slides). The pictures were packaged in pouches and delivered to the client or customer by regular mail. The client was then able to examine the pictures under controlled light conditions. The above procedure insured that no misunderstandings could occur with respect to the colors of the pictures.

With the onset of digital photography, the situation has dramatically changed. Currently, pictures are transmitted in digital form as bits and bytes. However, the only possibility to insure that the color information is correctly reproduced is by the use of International Color Consortium (ICC) color profiles. Professional photographers are aware of these difficulties in the digital processing of images and the ways and means to manage them. The customer on the other hand is not necessarily familiar with ICC techniques but wants to profit from the inherent advantages of digital processing of images (for example strongly reduced time between capture and display). Digital images are normally sent to the customer by e-mail or on a CD from which the customer can view the images on the screen of a computer. However, different from the classical analog world, a physical reference (“hard copy reference”) is no longer present, so that it can easily come to misunderstanding and dissatisfaction with respect to the color of the images.

### SUMMARY OF THE INVENTION

The above mentioned problems are addressed by the present disclosure. More specifically, a method is provided to give the recipient of digital color documents (for example digital photographs) information on whether a correct color reproduction during observation of the documents on his screen can be expected. This aspect underlying the invention is achieved by a process for the transmission from a first to at least one second computer of a digital color document generated or processed on the first computer by way of a color management enabled graphics application with the use of a monitor profile, whereby the digital data of the color document to be transmitted are packed in the first computer with an underlying monitor profile into a digital container document, the container document is transmitted to the second computer, the container document is unpacked in the second computer and the data of the color document and the underlying monitor profile are recovered, the unpacked monitor profile is compared with a local monitor profile active in the second computer, and the result of the comparison is displayed on the second computer.

This application claims priority to Application No. 04 010 724.5, filed May 5, 2004, in the European Patent Office, the contents of which are incorporated by reference in their entirety.

### BRIEF DESCRIPTION OF THE FIGURES

The invention is further described in the following disclosure in conjunction with the drawings enumerated below.

FIG. 1 is a principal block diagram of an exemplary embodiment of the process in accordance with the invention; and

FIG. 2 is a flow diagram of the process.

### DETAILED DESCRIPTION OF A PREFERRED EMBODIMENT

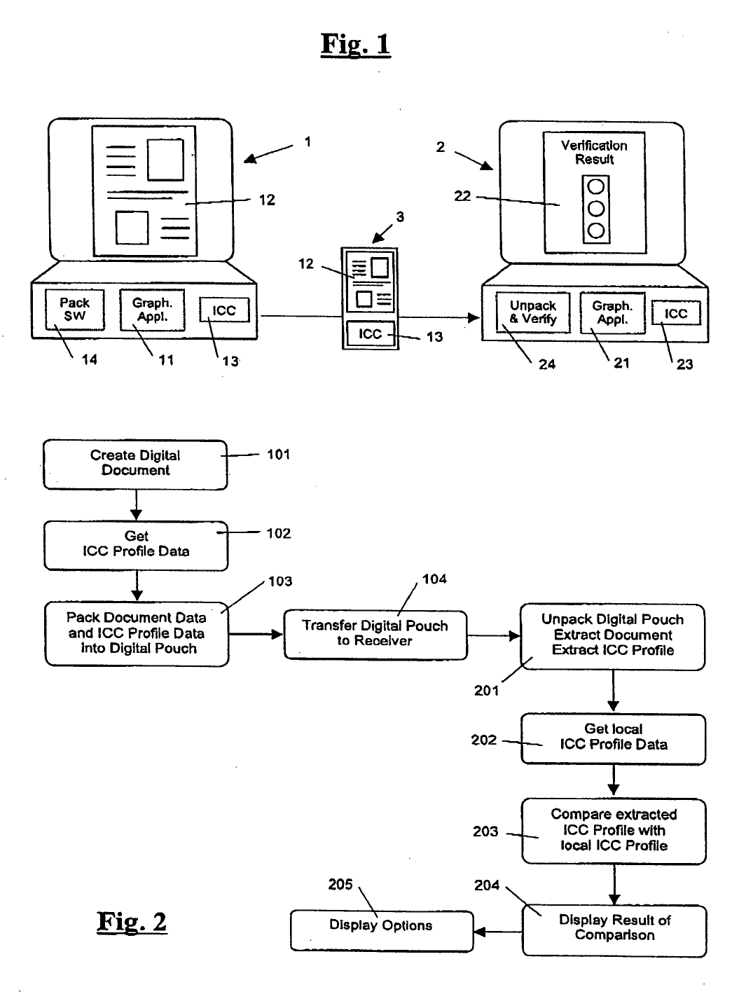

The components involved in the method according to an exemplary embodiment in accordance with the invention are schematically illustrated in FIG. 1. FIG. 1 illustrates a computer 1 of a photographer and a computer 2 of a customer who obtains and wants to examine digital color documents (e.g., generally digital pictures) created by the photographer.

A digital color document is generated or processed on a first computer by way of a color management enabled graphics application with the use of a monitor profile. The digital data of the color document are packed together with the underlying monitor profile into a digital container document and transmitted to a second computer. In the second computer, the container document is unpacked, whereby the data of the color document and the underlying monitor profile are recovered. The unpacked monitor profile is then compared with a local monitor profile active in the second computer and the result of the comparison is displayed on a monitor of the second computer.

A color management enabled graphics application 11 runs on the computer 1 of the photographer, by which the photographer generates or processes a color document 12. One understands hereunder, for example, the selection of image sections and the digital retouching of digital photographic images, which were previously read into the application. An ICC-Monitor-Profile 13 stored in the computer 1 is active for these actions and provides a true color representation on the monitor of the computer 1. This process block is labeled 101 in the flow diagram of FIG. 2.

When the photographer is finished with a job, which means the color document 12 is finished or fully processed, the photographer packs the digital data of the color document 12 into a digital container document 3 and saves the latter. The digital container document 3 can be, for example, in a common digital archive format. The data of the active ICC-Monitor-Profile 13 or at least its most important parameters (e.g., base colors, white point, and/or luminance) are packed together with the color document 12 into the digital container document 3. The determination of the profile data and the packing thereof with the digital color document 12 into the container document 3 is carried out by way of a pack program 14 running on the computer 1. The corresponding processing blocks are labeled 102 and 103 in FIG. 2. In addition to the Monitor-Profile 13, further profiles, for example the profile of the digital camera with which the images were taken, or color space profiles, can also be packed into the digital container document 3. The digital container document 3 is thus in a way the digital analog to the conventional mailing pouch and is therefore also referred to as a “Digital Pouch”. The finalized digital container document 3 is now transmitted to the customer (processing block 104) by way of a suitable transport medium (for example by e-mail or CD). The customer receives the original digital container document 3 on computer 2 and opens it by way of an unpacking and verification program 24 running thereon. The data of the digital color document 12 and all of the profile data packed therewith, including the underlying ICC-Monitor-Profile 13, are thereby unpacked or recovered. This processing block is labeled 201 in FIG. 2.

A graphics application 21 is installed on the computer 2 of the customer by which the unpacked digital color document 12 can be displayed on the monitor of the computer 2. Preferably, a local ICC-Monitor-Profile 23 is also active on the computer 2 of the customer.

The unpacking and verification program 24 now determines the data of the local ICC-Monitor-Profile 23 (if present) and compares the data of the local ICC-Monitor-Profile 23 with the data of the monitor profile 13 extracted from the digital container document 3 (blocks 202 and 203 in FIG. 2). It is thereby examined whether a local monitor profile 23 is active at all and, if applicable, how far it corresponds with the monitor profile 13. The better the correspondence between the local monitor profile 23 and the monitor profile 13, the better the color trueness to be expected upon display of the color document 12 on the monitor of the computer 2 of the customer.

The result of this verification or comparison of the profile data is then displayed by the packing and verification program 24 on the monitor of the computer 2 of the customer and preferably in the form of plain screen messages 22 easily understandable by the user. For example in one embodiment, a traffic light type signaling format (as illustrated) with traffic light colors green, yellow and red can be provided, but is not limited thereto. A signal light showing green would signal that a true color reproduction of the color document 12 is to be expected. The color red would indicate the opposite and a traffic light showing yellow would indicate to the user that the user should expect small color deviations. The corresponding processing block is labeled 204 in FIG. 2. Of course, separate programs can also be used for the unpacking of the digital container document 3 and the verification of the monitor profile data.

The unpacking and verification program 24 (or a separate verification program) can also include further functions which offer the user suitable options for problem correction depending on the result of the verification or comparison, or which point to further options. For example, when an active local monitor profile 23 is missing, the user can be notified or requested to generate and install a profile. A similar notification can be given for an unsuitable monitor profile or one already showing a certain age. Furthermore, a request for a new calibration of the monitor can be made and eventually even programming support for the execution of the suggested or required actions can be offered. The display of sensible situation-based options for the reaction to the result of the comparison is indicated at block 205 in FIG. 2.

Although the present disclosure has been provided with reference to exemplary embodiments thereof, the present disclosure is not to be limited thereto. Rather, modifications, enhancements and/or variations to the disclosed devices, systems and features are contemplated, and such modifications, enhancements and/or variations will not depart from the spirit or scope of the present disclosure.

What is claimed is:

1. A method for transmitting a digital color document from a first computer to at least one second computer, the method comprising:
generating the digital color document on the first computer by way of a color management enabled graphics application using a monitor profile;
packing, digital data of the digital color document to be transmitted in the first computer together with the underlying monitor profile into a digital container document;
transmitting the container document to the second computer;
unpacking the container document in the second computer, the unpacked container document includes recovering the data of the color document and the underlying monitor profile;
comparing the unpacked monitor profile with a local monitor profile active in the second computer; and
displaying the result of the comparison on a monitor of the second computer.

2. The method according to claim 1, wherein the result of the comparison is displayed as one of two or three possible conditions.

3. The method according to claim 1, wherein depending on the comparison outcome, options for reaction to the comparison outcome are displayed on the second computer.

4. The method according to claim 3, wherein the options include a request to generate and install a profile.

5. The method according to claim 3, wherein the options include a request for a new calibration of the monitor of the second computer.

6. The method according to claim 2, wherein the comparison is indicative of the color trueness to be expected upon display of the color document on a monitor of the second computer.

7. The method according to claim 6, wherein when the result of the comparison is displayed as three possible conditions, a first condition would signal that a true color reproduction of the color document is to be expected, a second condition would indicate the opposite, and a third condition would indicate to the user that the user should expect small color deviations in the color document.

8. The method according to claim 7, wherein the first, second and third conditions are indicated with a corresponding green, red and yellow light display, respectively.
